(19) United States
(12) Patent Application Publication
(10) Pub. No.: US 2019/0197518 A1
(43) Pub. Date: Jun. 27, 2019

(54) SYSTEM AND METHOD USING STORED VALUE TOKENS

(71) Applicant: MASTERCARD ASIA/PACIFIC PTE. LTD., Singapore (SG)

(72) Inventors: Tobias Puehse, Singapore (SG); Charu Jain, Singapore (SG)

(21) Appl. No.: 16/209,411

(22) Filed: Dec. 4, 2018

(30) Foreign Application Priority Data
Dec. 22, 2017 (SG) 10201710759U

(51) Int. Cl. G06Q 20/32; G06Q 20/36; G06Q 20/40

(52) U.S. Cl. CPC G06Q 20/3278; G06Q 20/4014; G06Q 20/3678

(57) ABSTRACT

According to an aspect, there is provided a system including: a stored value token having an associated token value; a token validation server; and a computing device in communication with the token validation server; wherein the computing device is configured to: read token data comprising a token identifier and a token status from the stored value token; validate the stored value token, comprising transmitting the token identifier to the token validation server; in response to receiving a pay-out instruction, instruct the stored value token to change the token status to active, and deducting the associated token value from a predetermined account; and in response to receiving a pay-in instruction, instruct the stored value token to change the token status to inactive, and add the associated token value to the predetermined account.

### CROSS-REFERENCE TO RELATED APPLICATION

This application claims the benefit of and priority to Singapore Patent Application No. 10201710759U filed Dec. 22, 2017. The entire disclosure of the above application is incorporated herein by reference.

### FIELD

The present disclosure relates broadly, but not exclusively, to systems and methods using a stored value token.

### BACKGROUND

This section provides background information related to the present disclosure which is not necessarily prior art.

Users, despite having access to digital/card products, have an interest and need for the physicality of money to manage their expenses and have reassurance/information of available funds. Digital information sources like SMS or websites of the internet are often not available in real time or not sufficiently accessible to make use of them for on the spot payments.

Further, governments currently spend millions on minting coins and paper for circulations, and thus are increasingly looking into alternatives to increase transparency, cost effectiveness, reduce fraud, and reduce social costs related to cash (for example theft and tax evasion), and protection of cash, among others.

Furthermore, trips to banks in order to get cash may be cumbersome for users and merchants alike.

A need therefore exists to provide methods and/or systems to address at least some of the above problems.

### SUMMARY

This section provides a general summary of the disclosure, and is not a comprehensive disclosure of its full scope or all of its features. Aspects and embodiments of the disclosure are set out in the accompanying claims.

According to a first aspect, there is provided a method of using a stored value token, the method including: reading token data from the stored value token, the token data comprising a token identifier and a token status, the stored value token having an associated token value; transmitting the token identifier to a token validation server and validating the stored value token in response to communication from the token validation server; changing the token status in response to an input, wherein the input is either a pay-out instruction or a pay-in instruction; in response to the pay-out instruction, changing the token status to active and deducting an amount equivalent to the associated token value from a predetermined account; and in response to the pay-in instruction, changing the token status to inactive and adding the amount equivalent to the associated token value to the predetermined account.

According to a second aspect, there is provided a system including: a stored value token having an associated token value; a token validation server; and a computing device in communication with the token validation server; wherein the computing device is configured to: read token data comprising a token identifier and a token status from the stored value token; transmit the token identifier to the token validation server; validate the stored value token in response to communication from the token validation server; in response to receiving a pay-out instruction, instruct the stored value token to change the token status to active, and deducting the associated token value from a predetermined account; and in response to receiving a pay-in instruction, instruct the stored value token to change the token status to inactive, and add the associated token value to the predetermined account.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, embodiments and implementations are provided by way of example only, and will be better understood and readily apparent to one of ordinary skill in the art from the following written description, read in conjunction with the drawings, in which:

FIG. 1A shows a system for using stored value tokens according to various embodiments;

FIG. 1B shows a structural illustration of the stored value token according to various embodiments;

FIG. 2A shows a flow diagram illustrating a method of using a stored value token according to various embodiments;

FIG. 2B shows a flow diagram of activating inactive stored value tokens

FIG. 2C shows a flow diagram illustrating how to use a stored value token according to various embodiments;

FIG. 2D shows a flow diagram illustrating how to use a stored value token according to various embodiments;

FIG. 3 shows a diagram illustrating an information flow with or without transparency on digital token ownership according to various embodiments; and

FIG. 4 depicts an exemplary computing device according to various embodiments.

Corresponding reference numerals indicate corresponding parts throughout the several views of the drawings.

### DETAILED DESCRIPTION

Embodiments will be described, by way of example only, with reference to the drawings. The description and specific examples included herein are intended for purposes of illustration only and are not intended to limit the scope of the present disclosure. And again, like reference numerals and characters in the drawings refer to like elements or equivalents.

It is the intent of the present embodiments to present systems and methods that allow for a way of conducting transaction, as a supplement to or substitute for cash, for example to provide a distributed supply system and method for currency, which may be used like cash without various drawbacks of cash. A method of using a stored value token is provided which includes: reading token data from the stored value token, the token data including a token identifier and a token status and the stored value token having an associated token value; transmitting the token identifier to a token validation server and validating the stored value token in response to communication from the token validation server; and changing the token status in response to an input, wherein the input is either a pay-out instruction or a pay-in instruction. In response to the pay-out instruction, the token status is changed to active and an amount equivalent to the associated token value is deducted from a predetermined account. In response to the pay-in instruction, the token status is changed to inactive and the amount equivalent to the associated token value is added to the predetermined account.

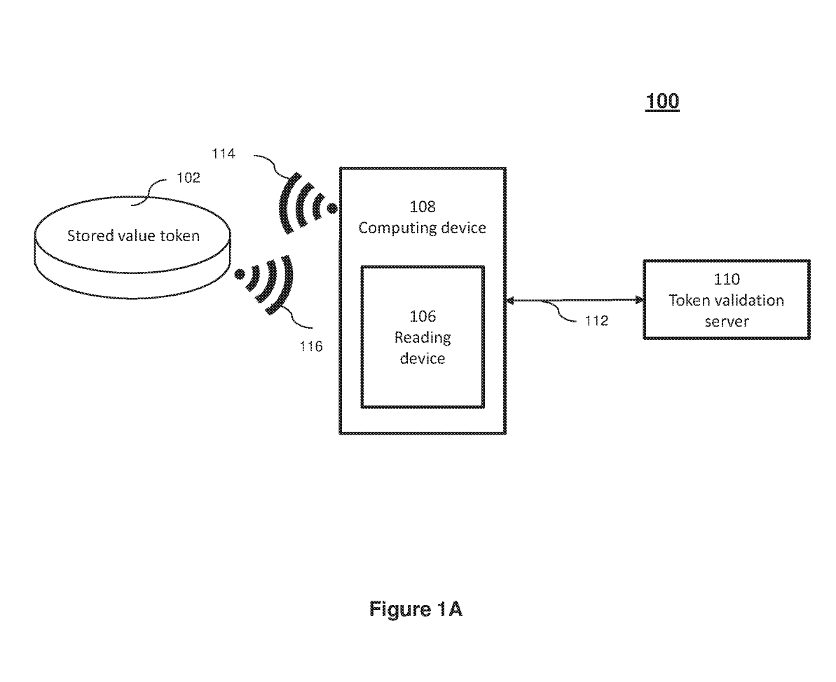

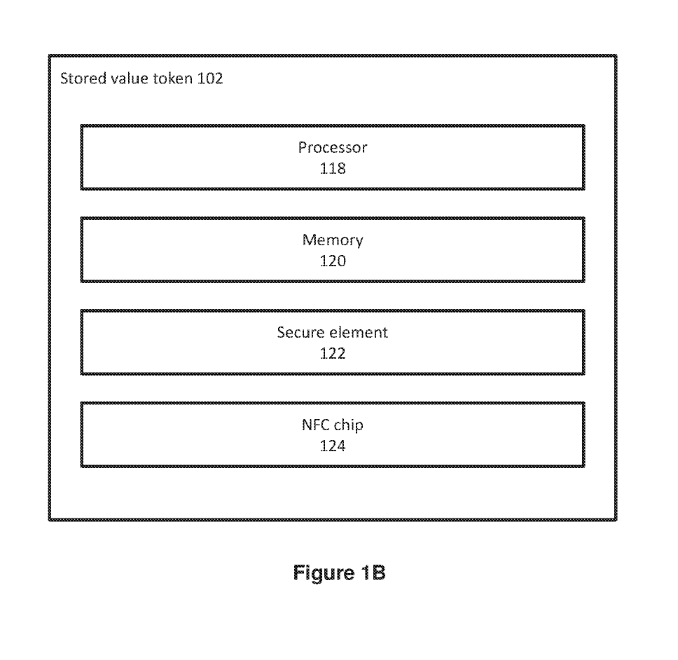

FIG. 1A shows a block diagram of a system 100 for using stored value tokens according to various embodiments. A stored value token 102 is depicted which may have the physical appearance of a coin or a bank note, and which may be made from plastic or paper or any other suitable material. The stored value token 102 may be lightweight, yet robust and durable.

FIG. 1B shows a structural illustration of the stored value token 102 according to various embodiments. The stored value token 102 includes a memory 120 and a processor 118 for controlling the operation of the stored value token 102. The stored value token 102 may include a secure element 122 configured to store token data that is used to process the stored value token 102. The secure element 122 is provided to provide enhanced security for the token data. All of the token data or part of the token data may be stored in the secure element 122. To the extent that the secure element 122 includes processing capabilities, it may functionally overlap with the processor 118, and to the extent that the secure element 122 includes storable capabilities, it may functionally overlap with the memory 120. While the components of the stored value token 102 have been shown as separate elements, embodiments may integrate or combine the different components into one or more devices as required.

The secure element 122 may be a microprocessor chip (which may include a plurality of circuits), which can store sensitive data and run secure apps. The secure element 122 may have the function of a vault to protect data stored inside the secure element 122. Besides storing the token data, the secure element 122 may also include functionality related to NFC communication, and may protect data associated with that functionality.

In accordance with the present embodiment, the token data includes a token identifier (for example, a unique number or a string that is stored on that stored value token 102 and that may thus be used to identify the stored value token 102 based on that unique number or string) and a token status (which may for example be active, or inactive, or paused, like will be described in more detail below). The stored value token 102 may include a visual indicator configured to visually indicate the token status.

The stored value token 102 may have an associated token value. For example, there may be a fixed token value associated with the stored value token 102, and the fixed token value may not be changed. The fixed token value may be indicated on the exterior of the fixed token value, for example it may be printed or imprinted on the surface of the fixed token value. The fixed token value may also be shown on a display.

In accordance with the present embodiment, the stored value token 102 is configured to be coupled to a reading device 106. For example, the reading device 106 may emit signals 114, which may be sensed and responded to by the stored value token 102, for example, in the form of response signals 116. For example, the communication between the stored value token 102 and the reading device 106 may occur using NFC (near field communication) protocol. For example, both the stored value token 102 and the reading device 106 may include NFC circuitry that may allow for such communication. In addition, the communication between the stored value token 102 and the reading device 106 may occur in accordance with any other suitable wireless communication method like infrared communication, ZigBee, Bluetooth, or WLAN (wireless local area network).

The stored value token 102 may be a passive NFC device, requiring electrical energy from the reading device 106 for operation. In accordance with a variation of the present embodiment, the stored value token 102 may include a power interface configured to receive power from the reading device 106, for example, via inductive energy transmission. In another embodiment, the stored value token 102 may include an energy storage, for example, a battery. In yet another variation of the present embodiment, the stored value token 102 may include an energy harvesting unit, for example a photovoltaic element, or a piezoelectric element.

In one embodiment, the stored value token 102 includes an NFC chip 124 and the processor 118 is configured to control the NFC chip 124 to establish a secure connection with the computing device 108 so that data may be transmitted between the stored value token 102 and the computing device 108. In this embodiment, the stored value token 102 is a passive NFC device that is configured to switch on and be powered by a magnetic field of the reading device 106, which is a compatible active NFC reader. The stored value token 102 can therefore use the energy from the NFC reader to encode and transmit its response. However, according to other embodiments, the stored value token 102 may also be an active NFC device or may communicate with the computing device 108 using any other suitable wireless communication protocols.

The computing device 108 may include a reading device 106, which may be used for any computations that may be carried out related to processing the stored value token 102. The computing device 108 may be a POS (point of sale) terminal if in a store, or a computer terminal at a bank, or a PC (personal computer) or a mobile device (for example, a mobile phone) if a user wants to use the stored value token anywhere outside a shop or bank.

The computing device 108 may be configured to be in communication with a token validation server 110, as indicated by arrow 112. The reading device 106 may read the token data from the stored value token and may then, when coupled to the token validation server 110, transmit the token identifier to the token validation server 110. In response to communication from the token validation server 110, the reading device 106 may validate the stored value token 102.

In response to receiving a pay-out instruction, the computing device 108 may instruct the stored value token 102 to change the token status to active, and the computing device 108 may initiate deducting the associated token value from a predetermined account. In response to receiving a pay-in instruction, the computing device 108 may instruct the stored value token to change the token status to inactive, and the computing device 108 may initiate adding the associated token value to the predetermined account.

In additional to the two statuses of “active” and “inactive”, the token status may be “paused”. For example, the stored value token 102 or the token validation server 110 may be configured to pause usability of the stored value token to temporarily de-activate the stored value token. In other words, when the token status is “active”, the user may carry out a pre-determined action, for example, depressing a button on the stored value token 102, or by using a computing device to send a specific request to the token validation server 110, usability of the stored value token 102 may be temporarily be put on hold. The computing device may also then change the status of the stored value token to “paused,” which can only be changed back to active by the user with the computing device. Upon resuming active statuses, the computing device will send a notification to the token validation server 110 that the stored value token is again active. For example in a situation where an owner (or holder) of the stored value token 102 does not want to spend it (i.e., does not want to pay it in), and wants to ensure that the stored value token 102 is not subject to theft or unauthorized pay-in, the owner may pause the stored value token 102. Thereafter, for example, once the owner wishes to again have the ability to use the stored value token 102, the stored value token 102 or the token validation server 110 may reactivate the stored value token 102, changing the status of the stored value token 102 back to active and resuming use of the stored value token 102. It may be required for the owner to authenticate himself before the de-pausing of the stored value token 102 may take effect.

The stored value token 102 may be associated with a user identifier of an owner of the stored value token 102 in the memory 104 of the stored value token and/or in the token validation server 110. As stored value tokens may pass from user to user, and from user to entities, the user identifier will be updated to reflect the current owner at any given time. The token validation server 110 may include a memory configured to store the association of the stored value token 102 with the identifier of the owner of the stored value token. The computing device 108 may further be configured to, in response to the pay-in instruction, verify that the pay-in instruction is received from the owner of the stored value token 102, and may instruct the stored value token 102 to change the token status to inactive and adding the associated token value to the predetermined account only if the pay-in instruction is verified to have been received from the owner of the stored value token 102. This may ensure that only an authorized owner of the stored value token 102 can use the stored value token 102 for payment or other transactions. Verification that the pay-in instruction is received from the owner of the stored value token 102 may also be referred to as authorization of the owner of the stored value token 102, and may be performed for example by requesting a password or PIN (personal identification number), or by biometric measurements (like finger print or iris scan).

With the system as described in FIG. 1A, digital physical payment may be provided. In this manner, according to various embodiments, a plurality of stored value tokens may be introduced into commerce, by or on behalf of the government or other authorized monetary authority, as a substitute for paper notes and currency. Similar to traditional currency, stored value token will be issued in varying denominations.

As described above, a stored value token (for example, in the physical appearance of a coin or a note) may be provided. For example, a pre-set value coin (for example an NFC coin, which may be understood to be an exemplary embodiment of a stored value token (for example in the shape of a plastic coin) provided with NFC circuitry) may be activated at the merchant terminal, but may be issued by or on behalf of the government. The coin may be interoperable across banks due to network technology and it may be anonymous or associated with an individual if a digital ID (identifier) is issued by the government.

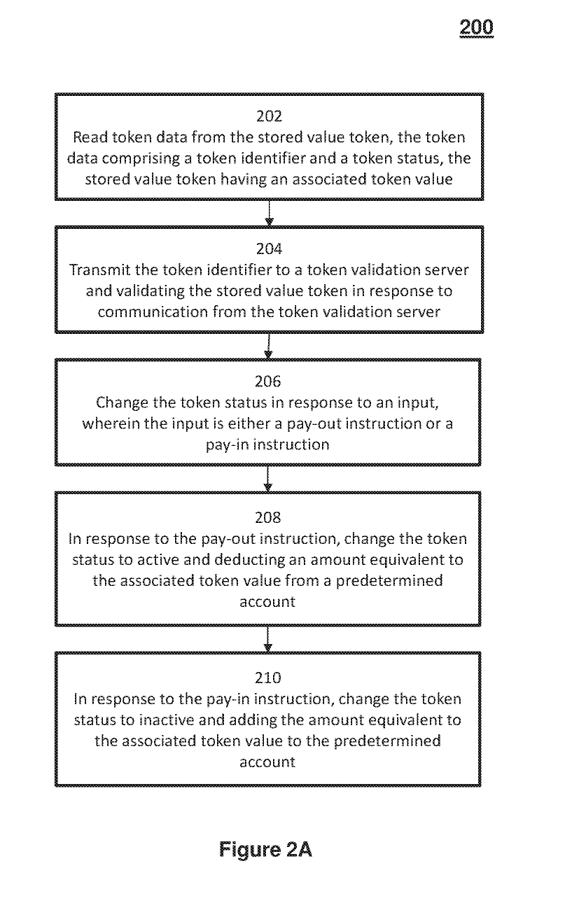

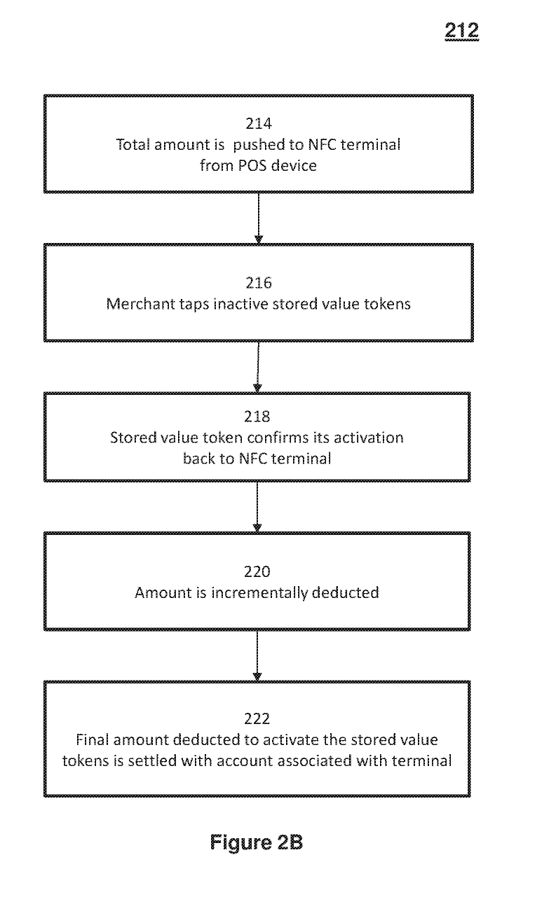

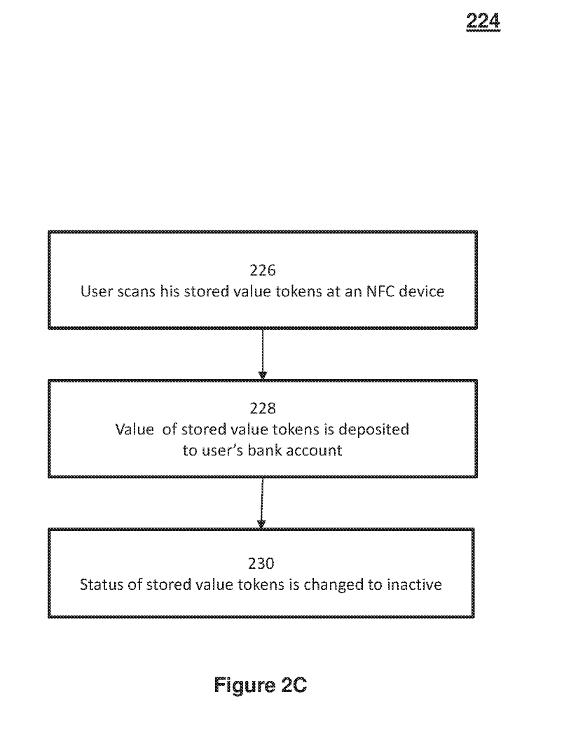

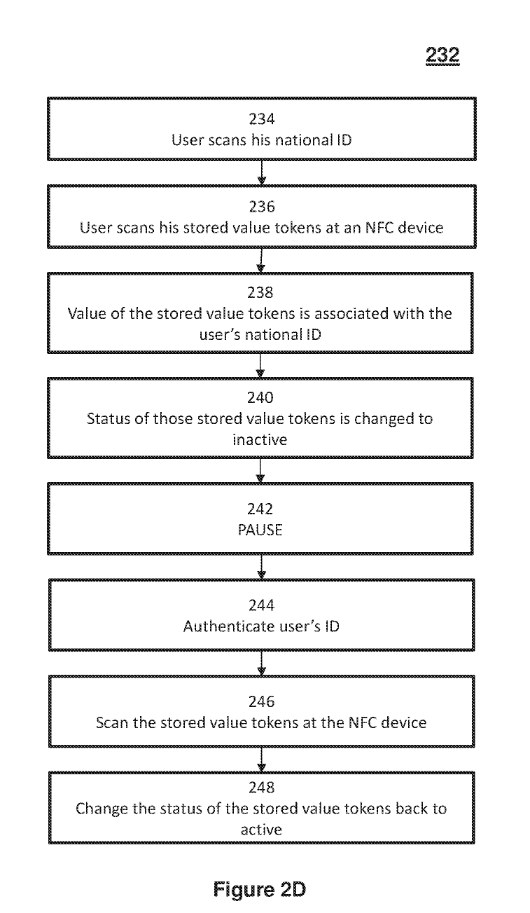

FIG. 2A shows a flow diagram 200 summarizing the processing in the system 100 shown in FIG. 1A. In 202, token data may be read from the stored value token. In 204, the token identifier may be transmitted to a token validation server and the stored value token may be validated in response to communication from the token validation server. In 206, the token status may be changed in response to an input, wherein the input is either a pay-out instruction or a pay-in instruction (for example, in 208, in response to the pay-out instruction, the token status may be changed to active and an amount equivalent to the associated token value may be deducted from a predetermined account. For example, in 210, in response to the pay-in instruction, the token status may be changed to inactive and the amount equivalent to the associated token value may be added to the predetermined account.

Other operations may also be performed using the stored value token 102 in response to use instructions. For example, in response to a “check status” instruction, the computing device 108 may transmit the token identifier to the token validation server 110 to validate the stored value token 102 and verify that it is valid and not a counterfeit, or confirm its value, or verify ownership information.

FIG. 2B shows a flow diagram 212 for activating inactive stored value tokens (which may also be referred to as “pay out”). According to various embodiments, if inactive stored value tokens are to be activated, in 214, the total amount to be paid out (in terms of stored value tokens), may be pushed to the NFC terminal (which may, for example, be a reading device) from a POS (point of sale) device. For example, on a POS device, the merchant may indicate the amount to be paid out, and information related to the amount is sent to the NFC terminal In 216, the merchant may tap the inactive stored value token or inactive stored value tokens (for example, the merchant may tap the stored value tokens one by one, until the requested amount has been paid out; for example, if an amount of $100 is to be paid out, and stored value tokens of a fixed amount of $10 are to be used, then the merchant may tap 10 inactive stored value tokens and may thus activate them one by one). In 218, each stored value token may confirm its activation back to the NFC terminal (for example, via an activation successful message), which may avoid that an amount is deducted from a user's account while the stored value token is not actually activated. In 220, the amount may be incrementally deducted until the total is reached and multiple tokens are given out (which has also been described above as a tapping and activating of stored value tokens one by one). In 222, the final amount deducted to activate the stored value tokens may be settled with the account associated with the terminal (in other words, instead of settling the amount related to each of the plurality of stored value tokens one by one, the overall amount may be deducted from the user's account; this may decrease communicative and administrative overhead due to several identical or similar transactions).

Similarly, when active stored value tokens are to be de-activated (which may also be referred to as “pay in”), active stored value tokens may be used until a total amount is reached at the merchant. The NFC terminal may confirm success and the token may be inactive. A pay in may also be done by any holder of a token (for example, at home).

FIG. 2C shows a flow diagram 224 illustrating how to use a stored value token according to various embodiments. For example, a user may be at home. In 226, the user may scan his stored value tokens at an NFC device, for example at an NFC enabled mobile phone. In 228, the value of those stored value tokens may then be deposited to the user's bank account. In 230, the status of those stored value tokens may be changed to inactive. In this way, should those stored value tokens be stolen from his home, they will have no value and the user will not lose any value/currency. Similar to the pay out, also for the pay in, first the stored value tokens may be processed (in the case of pay in: deactivated) one by one, and then the overall amount may be settled with the user's bank account, which may reduce overhead of several transactions.

FIG. 2D shows a flow diagram 232 illustrating how to use a stored value token according to various embodiments for pausing usability of the stored value token. For example a user may be at home. In 234, the user may scan his national ID (identity card), or any other document that may serve as document of authentication for the user. As will be seen later, the same document is used for temporarily deactivating (in other words: pausing) the stored value token and to subsequently resume (in other words: de-pause; in other words: re-activate) the stored value token. In 236, the user may scan his stored value tokens at an NFC device. In 238, the value of the stored value tokens may be associated with the user's national ID, which may ensure that only the holder of the user's national ID (which may be the user only) is in a position to de-pause the stored value tokens. In 240, the status of those stored value tokens may be changed to inactive. This may be considered a “hold” or “pause” (or a state in which the stored value tokens are locked or are not usable) on these stored value tokens, like indicated by 242. In 248, the user may change the status of the stored value tokens back to active (which may be considered as unlocking or de-pausing) after authenticating his identity card in 244 and then scanning the stored value tokens at the NFC device in 246. After scanning the user's identity card and the stored value tokens, it may be determined whether the identity card matches the identity card that has been scanned at the time of pausing the stored value tokens, and only if there is determined a match of the identity card (i.e., if the user has authenticated or validated himself by using his identity card), the stored value tokens are de-paused. This may prevent any unauthorized person to de-pause (and then use, for example pay in) the stored value tokens. It is possible that, while a stored value token is on hold, the value of that stored value token may temporarily be deposited to a government-linked account, which may ensure that even if the stored value tokens are destroyed or stolen while being paused, there is no monetary damage to the owner of the paused stored value tokens.

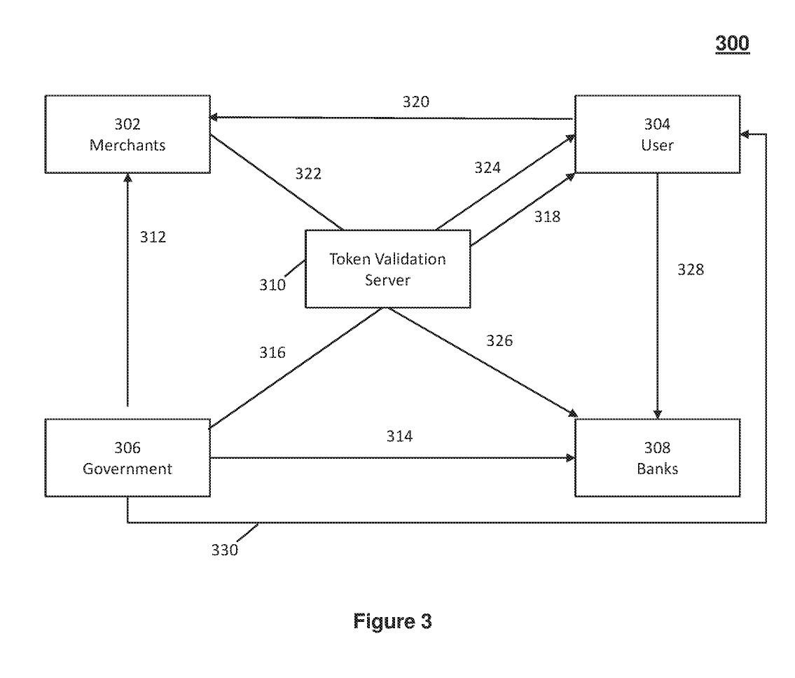

FIG. 3 shows a diagram illustrating an information flow between a merchant 302, a user 304, a bank 308, a government (or monetary authority) 306, and a token validation server 310, either with full transparency on stored value token ownership or without transparency on stored value token ownership according to various embodiments. The different entities shown in FIG. 3 may communicate with each other using any suitable communication protocol, such as on the internet using suitable internet communication protocols.

As illustrated by arrows 312 and 314, the government 306 may issue inactive digital stored value tokens with set values to merchants 302 and/or banks 308. The stored value tokens may be manufactured and distributed similar to the introduction of traditional currency to a national economy and/or connect to a national digital crypto currency. The stored value tokens could be used to securely store a national digital crypto currency.

In the case of full transparency on digital token ownership, the government 306 may issue a government ID (identification) card to its citizens, who will be users 304, as illustrated by arrows 316 and 318, so that each user of the stored value token has a government-issued identification number. Entities, such as companies and organizations, may also have government ID numbers. Each of the stored value tokens in circulation may be associated with a government ID number.

In an embodiment without transparency, the stored value tokens are not associated with a government ID number.

As illustrated by arrow 320, the merchant 302 may tap stored value tokens at a computing device, for example on a terminal, in order to change the status of the stored value token. In an example with full transparency of stored value token ownership, the user 304 may also tap a digital ID on the computing device, before the merchant 302 taps the stored value token to change the status of the stored value token. Once accepted, the stored value tokens may be inactive and become part of the merchant's inventory of available stored value tokens to provision to other users for future transactions.

As illustrated by arrows 322 and 324, the merchant 302 may provision stored value tokens by tapping them on the computing device or otherwise holding them within range of the reading device of the computing device. The value of the stored value tokens may then be deducted from a merchant account. A receipt may be given to the user 304 to confirm validity of provisioned stored value tokens.

Therefore, the token validation server 310 may provide merchant, users (for example consumers), and any other users with the interoperability of universally accepted contactless payment method.

In case of full transparency of stored value token ownership, as illustrated by arrow 328, due to government ID association, stored value tokens are associated with the government ID number of current owner of the stored value token. The token validation server may store a digital record of all stored value tokens in circulation. Specifically identified stored value tokens may be deactivated and effectively removed from circulation in the case of theft or loss. Then new stored value tokens may be reissued to user 304, and furthermore, governments may obtain records on payments made using the stored value token, which may avoid tax evasion since every transaction is recorded and assigned to the involved transaction parties. Otherwise (i.e., in an example without transparency of stored value token ownership), no on-going record of coins may be associated with a user 304, but the user 304 may deposit coins into account/digital wallet similar to cash today. In case of dispute/theft, tracking may be possible, and “fake” currency is effectively stamped out.

In embodiments of the invention, the value of each stored value token 102 may be fixed at the time it is issued by, or on behalf of, the government. This value is fixed once the stored value token 102 is in circulation. If the stored value token 102 is taken out of circulation, such as by the government, the government may change the value of that token, but that new value will be fixed upon being reintroduced into circulation. No account or credit card details may be stored on the stored value token 102.

In another example embodiment, the value of each stored value token 102 may be updated once it is in circulation. For example, by or on behalf of the government or other authorized authority, in response to changes in supply and demand for certain denominations of stored value tokens, the token value may be updated between when the token value is paid in and when it is paid out again to another user (in other words: the token value may be changed by the government or other authorized authority only when the stored value token is not active; for example, the token value of the stored value token may be set at time of paying it out to a user, which may allow simplified logistics, because stored value tokens can be paid out with different values, so that there is a higher flexibility in usage of the stored value token). Upon updating, the stored value token 102 may indicate its updated token value, the token data will be updated, and the token data on the token validation server 110 will be updated.

As illustrated by arrow 330, the government 306 may issue stored value tokens directly to the customer 304.

The token validation server 310 may provide for routing of information (for example from or to an account of the user 304 or from and to an account of the merchant 302) in a pre-configured way or a user-defined way.

It will be understood that singular use (e.g., merchant) and plural use (e.g., merchants) in FIG. 3 are provided in order to provide a better understanding of the information interflow. Each information will flow from one entity (e.g., user or consumer) to another (e.g., merchant), but similar information may be provided for a high number of tokens, so that plural use may be more appropriate.

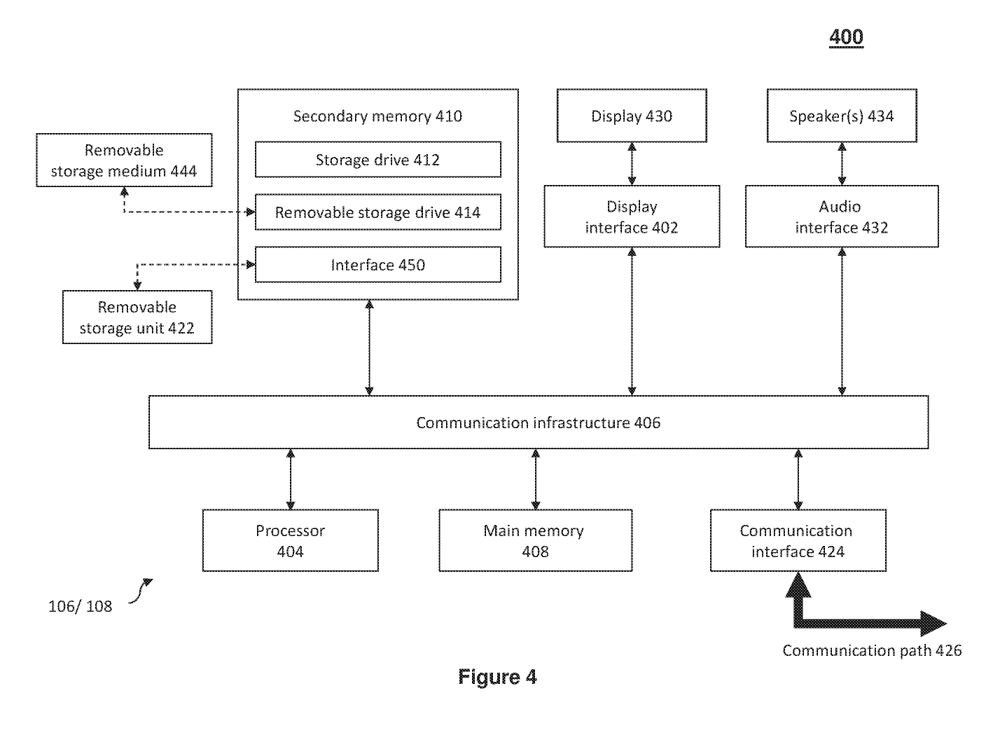

FIG. 4 depicts an exemplary computing device 400, hereinafter interchangeably referred to as a computer system 400 or as a server 400, where one or more such computing devices 400 may be used to implement the reading device 106, and/or the computing device 108, and/or the token validation server 110 and/or a computing device provided at either one or more of the merchants 302, the user 304, the token validation server 310, the government 306 or the banks 308, like illustrated in FIG. 3. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 414, which may include a magnetic tape drive, an optical disk drive, a solid state storage drive (such as a USB flash drive, a flash memory device, a solid state drive or a memory card), or the like. The removable storage drive 414 reads from and/or writes to a removable storage medium 444 in a well-known manner. The removable storage medium 444 may include magnetic tape, optical disk, non-volatile memory storage medium, or the like, which is read by and written to by removable storage drive 414. As will be appreciated by persons skilled in the relevant art(s), the removable storage medium 444 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 450. Examples of a removable storage unit 422 and interface 450 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 450 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the inventions, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port (such as a serial, parallel, printer, GPIB, IEEE 1394, RJ45, USB, etc.), an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” (or computer readable medium, which may be a non-transitory computer readable medium) may refer, in part, to removable storage medium 444, removable storage unit 422, a hard disk installed in storage drive 412, or a carrier wave carrying software over communication path 426 (wireless link or cable) to communication interface 424. Computer readable storage media (or computer readable media) refers to any non-transitory, non-volatile tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the storage drive 412, or the interface 450. The computer program product may be a non-transitory computer readable medium. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts. The main memory 408 and/or the secondary memory 410 may serve(s) as the memory for reading device 106, and/or the computing device 108, and/or the token validation server 110; while the processor 404 may serve as the processor of the reading device 106, and/or the computing device 108, and/or the token validation server 110.

It will be understood that while various embodiments have been described with respect to an NFC terminal, the various embodiments may operate with any type of NFC device that is configured to read and/or write from or to the stored value token. For example, the NFC terminal may be a mobile phone or other computing device with an NFC reader/writer.

Some portions of the description herein are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the description herein, it will be appreciated that throughout the present specification, discussions utilizing terms such as “determining”, “receiving”, “setting”, “effecting”, “supplying”, “invalidating”, “providing”, “associating”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses an apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of a more specialized apparatus to perform the required method steps may be appropriate. The structure of a computer suitable for executing the various methods/processes described herein will appear from the description herein.

In addition, the present specification also implicitly discloses a computer program, in that it would be apparent to the person skilled in the art that the individual steps of the method described herein may be put into effect by computer code, or may be the instructions of the computer readable medium described herein. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

According to various embodiments, various portions of the computing device, the reading device and/or the token validation server may be implemented as software or hardware, or a combination of both software and hardware. For example, various portions of the computing device, the reading device and/or the token validation server may include a circuit, and a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g. a computer program using a virtual machine code such as e.g., Java. Any other kind of implementation of the respective functions which will be described in more detail below may also be understood as a “circuit” in accordance with an alternative embodiment.

It will be understood that functionality of one or more circuits may be combined in a single circuit or split up into several circuits.

Various features are described for a device, but may analogously also be provided for a method, and vice versa.

Various embodiments provide a disruptive way for governments and banks to issue currency to their eco-systems where users, due to a lack of digital literacy, still rely heavily on the physicality of money to manage daily expenses and savings.

The method of using a stored value token may include: reading token data from the stored value token, the token data comprising a token identifier and a token status, the stored value token having an associated token value; transmitting the token identifier to a token validation server and validating the stored value token in response to communication from the token validation server; changing the token status in response to an input, wherein the input is either a pay-out instruction or a pay-in instruction; in response to the pay-out instruction, changing the token status to active and deducting an amount equivalent to the associated token value from a predetermined account; and in response to the pay-in instruction, changing the token status to inactive and adding the amount equivalent to the associated token value to the predetermined account.

The key advantageous features of the systems and methods using a stored value token will be summarized in the following.

In various embodiments, token data may be read from the stored value token. The token data may include a token identifier and a token status, the stored value token having an associated token value. This may allow to have a stored value token which may be set active for use, and may be de-activated when not in use, so that there is no risk of theft of the stored value token.

In various embodiments, the token identifier may be transmitting to a token validation server and the stored value token may be validated in response to communication from the token validation server. This may ensure that only legit stored value tokens are used (in other words: it is ensured that the stored value token is not counterfeit).

In various embodiments, the token status may be changed in response to an input, wherein the input is either a pay-out instruction or a pay-in instruction. In response to the pay-out instruction, changing the token status to active and deducting an amount equivalent to the associated token value from a predetermined account; and in response to the pay-in instruction, changing the token status to inactive and adding the amount equivalent to the associated token value to the predetermined account. This may allow to use the stored value tokens like cash for purchases.

In various embodiments, the associated token value may be included in the token data or stored on the token validation server. This may allow for a stored value token with a variable token value, which may however be fixed as long as the stored value token is active (in other words: the token value may only be set or changed at the time of activating the stored value token, which may simplify handling of the stored value token and may increase acceptance of the stored value token as an instrument of payment by the users or consumers). The memory of the stored value token stores may be a secure memory, which may make the stored value token tamper-proof.

In various embodiments, the stored value token may be linked with an identifier of an owner of the stored value token (which may be effected by storing the identifier of the owner of the stored value token in at least one of the memory or the token validation server), and in response to the pay-in instruction, it may be verified whether that the pay-in instruction is received from the owner of the stored value token, and changing the token status to inactive and adding the associated token value to the predetermined account only if the pay-in instruction is verified to have been received from the owner of the stored value token. This may ensure that only the legit owner of the stored value token has access to the value related to the token value, i.e., that only the legit owner can use the stored value token for payments.

In various embodiments, usability of the stored value token may be paused to temporarily de-activate the stored value token, and thereafter may be de-paused to re-activate the stored value token. This may allow safe storage of the stored value token, for example during a period of time where no use is intended. If a paused stored value token is lost or stolen, it may be useless for anyone except the legit owner of the stored value token.

In various embodiments, the stored value token may visually indicate the token status, which may increase user friendliness of the stored value token, because instead of reading the token status from a reading device, the token status may be read directly from the stored value token.

In various embodiments, the stored value token may receive power from a reading device, which may make the stored value token entirely passive, and thus light and cost efficient.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of using a stored value token, the method comprising:
reading, by a computing device, token data from the stored value token, the token data comprising a token identifier and a token status, the stored value token having an associated token value;
transmitting, by the computing device, the token identifier to a token validation server and validating the stored value token in response to communication from the token validation server;
changing, by the computing device, the token status in response to an input, wherein the input is either a pay-out instruction or a pay-in instruction;
in response to the pay-out instruction, changing the token status to active and deducting an amount equivalent to the associated token value from a predetermined account; and
in response to the pay-in instruction, changing the token status to inactive and adding the amount equivalent to the associated token value to the predetermined account.

2. The method of claim 1, wherein the associated token value is included in the token data or stored on the token validation server.

3. The method of claim 1, wherein the stored value token stores the token data in a secure element of the stored value token.

4. The method of claim 1, further comprising linking, by the computing device, the stored value token with an identifier of an owner of the stored value token.

5. The method of claim 4, wherein linking the stored value token comprises storing the identifier of the owner of the stored value token in at least one of a secure element of the stored value token and/or the token validation server.

6. The method of claim 4, further comprising, in response to the pay-in instruction, verifying that the pay-in instruction is received from the owner of the stored value token, and changing the token status to inactive and adding the associated token value to the predetermined account only if the pay-in instruction is verified to have been received from the owner of the stored value token.

7. The method of claim 1, further comprising pausing usability of the stored value token to temporarily de-activate the stored value token.

8. The method of claim 7, further comprising, thereafter, de-pausing usability of the stored value token to re-activate the stored value token.

9. The method of claim 1, wherein the stored value token visually indicates the token status.

10. The method of claim 1, wherein the stored value token receives power from a reading device associated with the computing device.

11. A system comprising:
a stored value token having an associated token value;
a token validation server; and
a computing device in communication with the token validation server;
wherein the computing device is configured to:
read token data comprising a token identifier and a token status from the stored value token;
transmit the token identifier to the token validation server;
validate the stored value token in response to communication from the token validation server;
in response to receiving a pay-out instruction, instruct the stored value token to change the token status to active, and deducting the associated token value from a predetermined account; and
in response to receiving a pay-in instruction, instruct the stored value token to change the token status to inactive, and add the associated token value to the predetermined account.

12. The system of claim 11, wherein the associated token value is included in the token data or stored on the token validation server.

13. The system of claim 11, wherein the stored value token comprises a secure element.

14. The system of claim 13, wherein the stored value token is associated with an identifier of an owner of the stored value token in at least one of the secure element and/or the token validation server.

15. The system of claim 14, wherein the token validation server comprises a memory configured to store the association of the stored value token with the identifier of the owner of the stored value token.

16. The system of claim 14, wherein the computing device is further configured to, in response to the pay-in instruction, verify that the pay-in instruction is received from the owner of the stored value token, and to instruct the token status to change the token status to inactive and add the associated token value to the predetermined account only if the pay-in instruction is verified to have been received from the owner of the stored value token.

17. The system of claim 11, wherein at least one of the stored value token and/or the token validation server is configured to pause usability of the stored value token to temporarily de-activate the stored value token.

18. The system of claim 17, wherein at least one of the stored value token and/or the token validation server is configured to, thereafter, de-pause usability of the stored value token to re-activate the stored value token.

19. The system of claim 11, wherein the stored value token further comprises a visual indicator configured to visually indicate the token status.

20. The system of claim 11, wherein the stored value token further comprises a power interface configured to receive power from the computing device.
